(19) United States
(12) Patent Application Publication
(10) Pub. No.: US 2019/0126849 A1
(43) Pub. Date: May 2, 2019

(54) VEHICLE DRIVING SUPPORT APPARATUS AND VEHICLE DRIVING SUPPORT PROGRAM

(71) Applicant: SHARP KABUSHIKI KAISHA, Osaka (JP)

(72) Inventors: KIMIHIRO HYOHDOH, Sakai City (JP); KAZUYUKI HORINOUCHI, Sakai City (JP); HIRONORI TANAKA, Sakai City (JP)

(21) Appl. No.: 16/147,721

(22) Filed: Sep. 29, 2018

(30) Foreign Application Priority Data
Oct. 26, 2017 (JP) 2017-207311

(51) Int. Cl. B60R 11/04; H04N 7/18

(52) U.S. Cl. CPC B60R 11/04; G01S 2013/9385; B60W 2420/403; H04N 7/18

(57) ABSTRACT

A vehicle driving support apparatus includes a first image capturing unit that captures images behind a vehicle and a second image capturing unit that captures images on a side of a front passenger seat. In a partial area where an imaging area of the first image capturing unit and an imaging area of the second image capturing unit are overlapped, visual lines of the first and the second image capturing units are overlapped. When the vehicle includes the first image capturing unit, the second image capturing unit, and a third image capturing unit that captures images on a side of the driver's seat, the visual line of the first image capturing unit and a visual line of the third image capturing unit are overlapped in a partial area where the imaging area of the first image capturing unit and an imaging area of the third image capturing unit are overlapped.

### BACKGROUND

### 1. Field

The present disclosure relates to a vehicle driving support apparatus and a vehicle driving support program.

### 2. Description of the Related Art

Japanese Unexamined Patent Application Publication No. 2010-245701 (disclosed on Oct. 28, 2010) describes a vehicle driving support apparatus that displays images captured by imaging a rear area and a rear/side area of the vehicle as a connection image on a display unit and causes a vehicle driver to be able to intuitively understand a direction in which the connection image is captured from the vehicle.

Japanese Unexamined Patent Application Publication No. 2003-255925 (disclosed on Sep. 10, 2003) describes a vehicle driving support apparatus which arranges two cameras whose viewing angles are 110° in the center of the rear of the vehicle so that imaging areas of the cameras overlaps with each other in a range of about 40° and displays a synthesized image obtained by synthesizing two images captured by the two cameras on a display unit.

However, in the vehicle driving support apparatus described in Japanese Unexamined Patent Application Publication No. 2010-245701, a position of an image capturing unit in the rear of the vehicle and a position of an image capturing unit in the rear/side of the vehicle as seen from a vehicle driver are different from each other, so that a viewing point difference occurs in images captured by these image capturing unit. Here, the vehicle driving support apparatus described in Japanese Unexamined Patent Application Publication No. 2010-245701 synthesizes a continuous one image by compressing images obtained by capturing images of positions adjacent to each other. The images are compressed, so that it is possible to display a synthesized image of an image captured by imaging an area behind the vehicle and an image captured by imaging an area laterally behind the vehicle on the display unit. However, there is a problem that a difference occurs between a feeling of distance in an area behind the vehicle, which the vehicle driver can recognize by actual viewing, and a feeling of distance in an area behind the vehicle, which the vehicle driver can recognize from the synthesized image.

As in the vehicle driving support apparatus described in Japanese Unexamined Patent Application Publication No. 2003-255925, when arranging two cameras whose viewing angles are 110° in the center of the rear of the vehicle so that imaging areas of the cameras overlaps with each other in a range of about 40°, a viewing angle in which an image can be captured in a horizontal direction from the rear of the vehicle is 180°, so that there is a problem that a blind area occurs laterally behind the vehicle.

It is desirable to provide a vehicle driving support apparatus where a driver does not feel strange about a distance in a visual line toward an area laterally behind the vehicle and which displays an image including no blind area in an area laterally behind the vehicle.

### SUMMARY

According to an aspect of the disclosure, there is provided a vehicle driving support apparatus including a first image capturing unit that captures images behind a vehicle, a second image capturing unit that captures images on one side of the vehicle, an image synthesizing unit that synthesizes images that are respectively captured by the first and the second image capturing units, and a display unit that displays a synthesized image that is synthesized by the image synthesizing unit. The second image capturing unit is an image capturing unit that captures images on a side of a front passenger seat of the vehicle, or an image capturing unit that captures images on the side of the front passenger seat and an image capturing unit that captures images on a side of a driver's seat. The first and the second image capturing units are arranged so that a visual line of the first image capturing unit and a visual line of the second image capturing unit are overlapped in at least a partial area of an overlapped area where an imaging area of the first image capturing unit and an imaging area of the second image capturing unit are overlapped.

According to another aspect of the disclosure, there is provided a vehicle driving support apparatus including a first image capturing unit that captures images behind a vehicle, a second image capturing unit that captures images on one side of the vehicle, an image synthesizing unit that synthesizes images that are respectively captured by the first image capturing unit and the second image capturing unit, and a display unit that displays a synthesized image that is synthesized by the image synthesizing unit. The second image capturing unit is an image capturing unit that captures images on a side of a front passenger seat of the vehicle, or an image capturing unit that captures images on the side of the front passenger seat and an image capturing unit that captures images on a side of a driver's seat.

The first and the second image capturing units are arranged so that an imaging area of the first image capturing unit and an imaging area of the second image capturing unit are overlapped. The image synthesizing unit matches a size of an object on a first captured image captured by the first image capturing unit and a size of an object on a second captured image captured by the second image capturing unit with each other in at least a partial area of the overlapped area, and thereafter synthesizes the first captured image and the second captured image.

### BRIEF DESCRIPTION OF THE DRAWINGS

FIG. 1 is a block for explaining an outline of a configuration of a vehicle driving support apparatus according to an aspect of the present disclosure;

FIG. 2 is a diagram for explaining an outline of viewing angles and an image synthesis area where a moving image is captured by the vehicle driving support apparatus according to the aspect of the present disclosure;

FIG. 3 is a diagram showing an example of images captured by image synthesizing units included in the vehicle driving support apparatus according to the aspect of the present disclosure;

FIG. 4 is a diagram showing an example of a synthesized image where the images in FIG. 3 are synthesized by the vehicle driving support apparatus according to the aspect of the present disclosure;

FIG. 5 is a diagram showing an example of a synthesized image where the images in FIG. 3 are synthesized by a vehicle driving support apparatus according to a modified example of the present disclosure;

FIG. 6 is a diagram for explaining an outline of viewing angles and an image synthesis area where a moving image is captured by the vehicle driving support apparatus according to an aspect of the present disclosure; and

FIG. 7 is a diagram for explaining an outline of viewing angles and an image synthesis area where a moving image is captured by the vehicle driving support apparatus according to an aspect of the present disclosure.

### DESCRIPTION OF THE EMBODIMENTS

[Vehicle Driving Support Apparatus according to First Aspect]

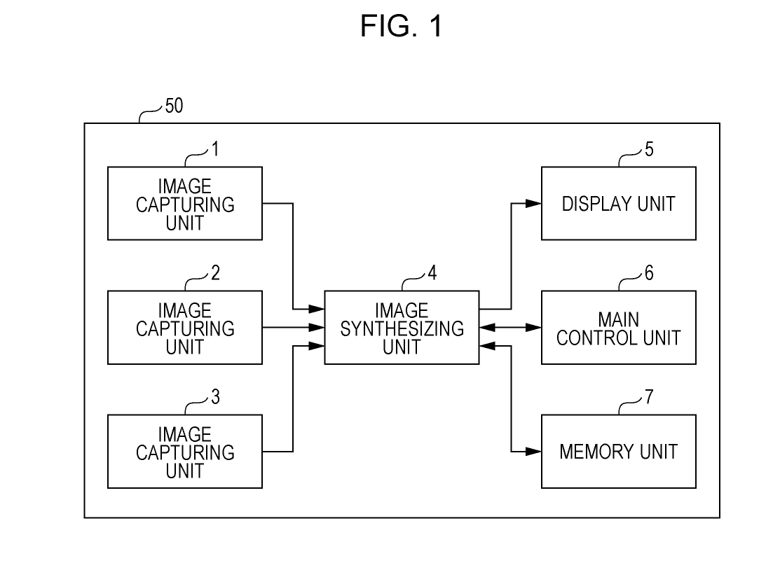

A vehicle driving support apparatus according to the present aspect will be described in detail with reference to FIGS. 1 to 4.

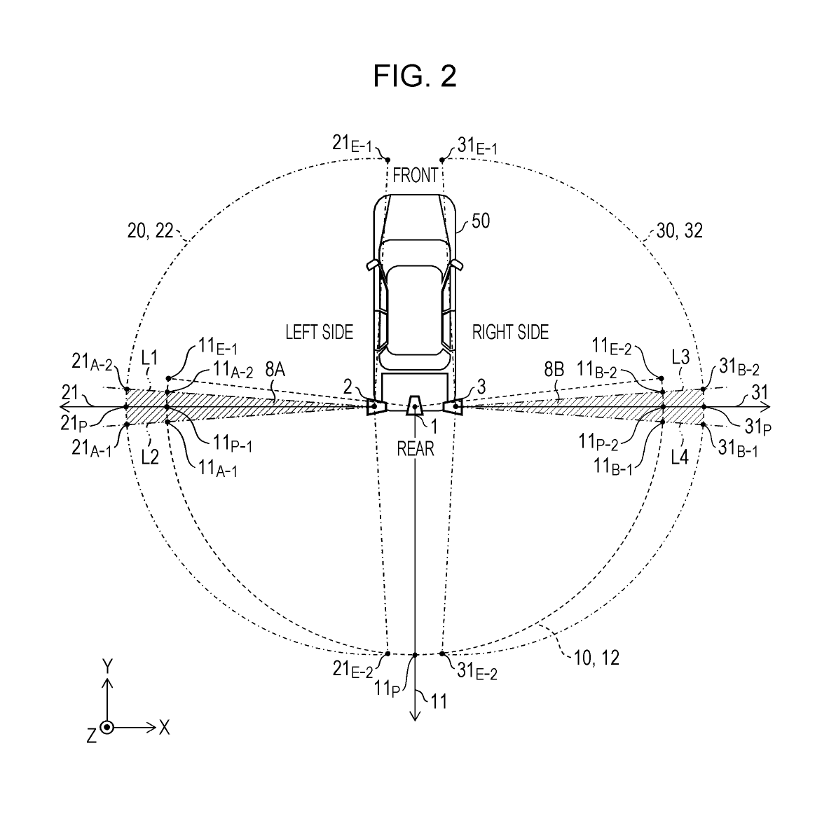

FIG. 1 is a diagram for explaining an outline of a configuration of the vehicle driving support apparatus according to the present aspect. FIG. 2 is a diagram for explaining an outline of viewing angles and an image synthesis area where a moving image is captured by the vehicle driving support apparatus according to the aspect of the present disclosure.

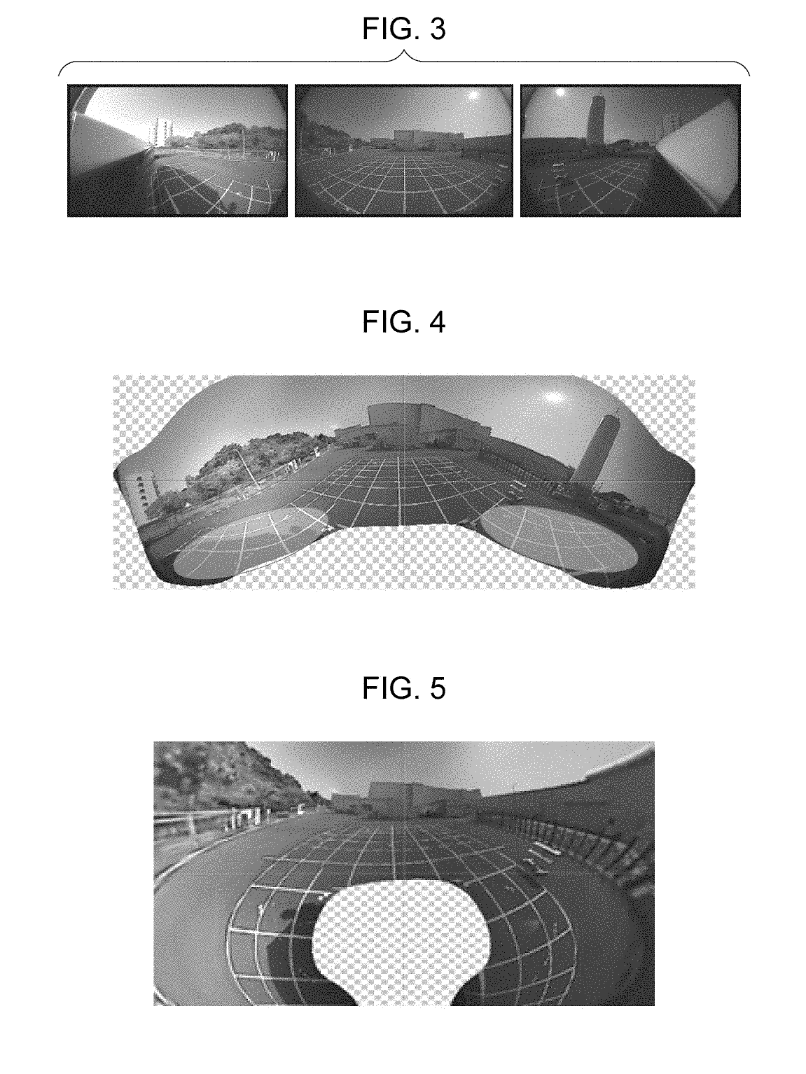

FIG. 3 shows images captured by image synthesizing units 1, 2, and 3 included in the vehicle driving support apparatus. FIG. 4 shows a synthesized image where the three images shown in FIG. 3 are synthesized into one image.

### (Image Capturing Unit)

As shown in FIG. 1, the vehicle driving support apparatus is a vehicle driving support apparatus composed of components provided in a vehicle 50 and includes an image capturing unit (first image capturing unit) 1 that captures images around the rear of the vehicle 50 from the rear of the vehicle 50, an image capturing unit (second image capturing unit) 2 that captures images on the left side of the vehicle (left side of the front passenger seat), and an image capturing unit 3 that captures images on the right side of the vehicle (right side of the driver's seat). The vehicle driving support apparatus further includes an image synthesizing unit 4, a display unit 5, a main control unit 6, and a memory unit 7. In the vehicle driving support apparatus according to the aspect, the second image capturing unit 2 that captures images on the side of the vehicle may be an image capturing unit that captures images on either the left side or the right side of the vehicle. In other words, in the vehicle driving support apparatus according to the aspect, the image capturing unit 3 that captures images on the right side of the vehicle may be an aspect of the second image capturing unit.

As shown in FIG. 2, the image capturing unit 1 is arranged in the center of the rear of the vehicle 50, the image capturing unit 2 is arranged in the rear left corner of the vehicle 50, and the image capturing unit 3 is arranged in the rear right corner of the vehicle 50. The image capturing unit 1, the image capturing unit 2, and the image capturing unit 3 are arranged so that the viewing points thereof are arranged in a row along a direction (X direction) perpendicular to a traveling direction of the vehicle 50 and are arranged so that the viewing point of the image capturing unit 1 is located between the viewing point of the image capturing unit 2 and the viewing point of the image capturing unit 3.

### (Imaging Area)

In FIG. 2, an imaging area 10 of the image capturing unit 1 is shown as an area defined by dashed lines. Here, each point shown on an arc of the imaging area 10 means a fixed point shown in an image (first captured image) 12 captured by the image capturing unit 1. In other words, each fixed point on the arc of the imaging area 10 shown in FIG. 2 is also a part of an object shown in the image 12. An angle formed by the viewing point of the image capturing unit 1 and an arc from a fixed point 11_{E-1} to a fixed point 11_{E-2} in the imaging area 10 means a horizontal viewing angle of the image capturing unit 1. The viewing angle of the image capturing unit 1 is preferable to be 180° or more. In the present aspect, the viewing angle of the image capturing unit 1 is 190°.

Similarly, in FIG. 2, an imaging area 20 of the image capturing unit 2 is shown as an area defined by dashed-dotted lines. Here, each point shown on an arc of the imaging area 20 means a fixed point shown in an image (second captured image) 22 captured by the image capturing unit 2. An angle formed by the viewing point of the image capturing unit 2 and an arc from a fixed point 21_{E-1} to a fixed point 21_{E-2} in the imaging area 20 means a horizontal viewing angle of the image capturing unit 2. The viewing angle of the imaging area 20 is preferable to be 180° or more. In the present aspect, the viewing angle of the imaging area 20 is 190°.

Similarly, an imaging area 30 of the image capturing unit 3 is shown as an area defined by dashed-dotted lines. Here, each point shown on an arc of the imaging area 30 means a fixed point shown in an image 32 captured by the image capturing unit 3. An angle formed by the viewing point of the image capturing unit 3 and an arc from a fixed point 31_{E-1} to a fixed point 31_{E-2} in the imaging area 30 means a horizontal viewing angle of the image capturing unit 3. The viewing angle of the imaging area 30 is preferable to be 180° or more. In the present aspect, the viewing angle of the imaging area 30 is 190°. The image 32 captured by the image capturing unit 3 may also be an aspect of the second captured image.

In addition, the viewing angles in a perpendicular direction of the image capturing units are not particularly limited but preferable to be equal to each other. The normal lines of imaging surfaces of the image capturing units are preferable to be horizontal to the ground (X-Y plane).

When no description is provided in the present specification, the viewing angle of each image capturing unit means a horizontal viewing angle, and the imaging area means an imaging area in the horizontal direction of an image.

### (Image Synthesizing Unit)

The image synthesizing unit 4 cuts out (trims) a part of each image and synthesizes a synthesized image by combining the cut-out images.

The imaging area 10 shown in FIG. 2 overlaps with the imaging area 20 on the left side of the vehicle 50 and overlaps with the imaging area 30 on the right side of the vehicle 50. An area where the imaging area 10 and the imaging area 20 are overlapped and an area where the imaging area 10 and the imaging area 30 are overlapped are referred to as overlapped areas.

The image synthesizing unit 4 deletes an area reflecting a range from a fixed point 11_{A-2} to the fixed point 11_{E-1} and an area reflecting a range from a fixed point 11_{B-2} to the fixed point 11_{E-2} on the arc of the imaging area 10 from the image 12. Thereby, the image 12 is cut out (trimmed) so that a range from the fixed point 11_{A-2} to the fixed point 11_{B-2} in the horizontal direction remains in an image. Further, the image synthesizing unit 4 cuts out an area reflecting a range from a fixed point 21_{A-1} to the fixed point 21_{E-1} on an arc of the imaging area 20 from the image 22 and similarly cuts out an area reflecting a range from a fixed point 31_{B-1} to the fixed point 31_{E-1} on an arc of the imaging area 30 from the image 32.

Subsequently, the image synthesizing unit 4 synthesizes the image 12, the image 22, and the image 32, which have been trimmed.

The image synthesizing unit 4 defines a part that occupies a range from the fixed point 21_{A-1} to a fixed point 21_{A-2} in the overlapped area of the imaging area 20 and the imaging area 10 as a partial area 8A, and defines a part that occupies a range from the fixed point 31_{A}- to a fixed point 31_{B-2} in the overlapped area of the imaging area 30 and the imaging area 10 as a partial area 8B. Here, a range from a fixed point 11_{A-1} to the fixed point 11_{A-2} in the imaging area 10 is located on the partial area 8A, and a range from a fixed point 11_{B-1} to the fixed point 11_{B-2} in the imaging area 10 is located on the partial area 8B. The image 12 and the image 22 are captured so that visual lines of the image capturing unit 1 and the image capturing unit 2 are overlapped in the partial area 8A, and the same scenery is captured except that the positions of the viewing points are different in the X direction in FIG. 2. Similarly, the image 12 and the image 32 are captured so that visual lines of the image capturing unit 1 and the image capturing unit 3 are overlapped in the partial area 8B, and the same scenery is captured except that the positions of the viewing points are different in the X direction in FIG. 2.

Therefore, the image synthesizing unit 4 can successfully match the size of the scenery of the partial area 8A shown in a range from the fixed point 11_{A-1} to the fixed point 11_{A-2} in the image 12 with the size of the scenery of the partial area 8A shown in a range from the fixed point 21_{A-1} to the fixed point 21_{A-2} in the image 22. Further, the image synthesizing unit 4 can successfully match the size of the scenery of the partial area 8B shown in a range from the fixed point 11_{B-1} to the fixed point 11_{B-2} in the image 12 with the size of the scenery of the partial area 8B shown in a range from the fixed point 31_{B-1} to the fixed point 31_{B-2} in the image 32.

In the vehicle driving support apparatus according to the present aspect, in FIG. 2, the image synthesizing unit 4 synthesizes images so that the size of the scenery shown in an area from the fixed point 11_{A-1} to the fixed point 11_{A-2} in the image 12 matches with the size of the scenery shown in an area from the fixed point 21_{A-1} to the fixed point 21_{A-2} in the image 22, and synthesizes images so that the size of the scenery shown in an area from the fixed point 11_{B-1} to the fixed point 11_{B-2} in the image 12 matches with the size of the scenery shown in an area from the fixed point 31_{B-1} to the fixed point 31_{B-2} in the image 32. Therefore, in a synthesized image, the images 12, 22, and 32 are synthesized so that a feeling of distance does not vary in both long distance and short distance in a visual line 11 facing rearward from the center of the rear portion of the vehicle 50, a visual line 21 facing left side from the left corner of the rear portion of the vehicle 50, and a visual line 31 facing right side from the right corner of the rear portion of the vehicle 50.

FIG. 3 shows images captured respectively by the image capturing unit 1, the image capturing unit 2, and the image capturing unit 3. The image located in at the center of the three images shown in FIG. 3 corresponds to the image (first captured image) 12 in FIG. 2. The right side image shown in FIG. 3 corresponds to the image (second captured image) 22 in FIG. 2. The left side image shown in FIG. 3 corresponds to the image 32 in FIG. 2. When simply combining such three images, there is a problem that an object is doubly reflected or a blind area occurs near a boundary between the images. On the other hand, the problem that an object is doubly reflected or a blind area occurs is solved by synthesizing the images shown in FIG. 3 into one image by overlapping the images in the partial areas 8A and 8B shown in FIG. 2 after adjusting the sizes of the object in the partial areas 8A and 8B.

FIG. 4 shows a synthesized image obtained by synthesizing the three images shown in FIG. 3. A driver who sees the display unit 5 can recognize the synthesized image shown in FIG. 4 so that there is no difference between feelings of distance in the rear direction and the left and right directions of the vehicle based on the rear portion of the vehicle in the synthesized image shown in FIG. 4. In the synthesized image shown in FIG. 4, there is no blind area in the rear direction and the left and right directions of the vehicle.

### [Display Unit]

A driver of the vehicle 50 visually recognizes the synthesized image, which is synthesized from the images 12, 22, and 32 and is displayed by the display unit 5. The display unit 5 can also display a moving image formed by a series of synthesized images that are continuously synthesized by the image synthesizing unit 4. Therefore, in the moving image displayed on the display unit 5, even while the viewing points of the image capturing units 1, 2, and 3 are moving, the driver can recognize the moving image so that there is no difference between feelings of distance in the rear direction and the left and right directions of the vehicle 50. The display unit 5 may be any display unit such as a liquid crystal display mounted in the vehicle 50. For example, a display installed in a car navigation system or a car audio may be used as the display unit 5.

The main control unit 6 controls an entire system of the vehicle driving support apparatus. The main control unit 6 controls the image synthesizing unit 4 and synthesizes images captured by the image capturing unit 1, 2, and 3. In addition, the main control unit 6 may include an input unit for inputting information inputted by the driver and may control brightness and the like of the synthesized image displayed on the display unit 5 based on data inputted from the input unit. Further, as an example, the main control unit 6 can perform control so as to switch whether to display the synthesized image as a moving image or to display the synthesized image as a still image on the display 5.

The memory unit 8 records software and the like for synthesizing images. Further, the memory unit 8 can store an image displayed by the display unit 5 as data.

### Modified Example

The vehicle driving support apparatus according to the present disclosure is not limited to the aspect (first aspect) described above. In a vehicle driving support apparatus according to a modified example, in FIG. 2, the image synthesizing unit 4 synthesizes the image 12 and the image 22 so that the size of the scenery shown in an area from the fixed point 21_{A-1} to the fixed point 21_{A-2} in the image 22 matches with the size of the scenery shown in an area from the fixed point 11_{A-1} to the fixed point 11_{A-2} in the image 12. Further, the image synthesizing unit 4 synthesizes the image 12 and the image 32 so that the size of the scenery shown in an area from the fixed point 31_{B-1} to the fixed point 31_{B-2} in the image 32 matches with the size of the scenery shown in an area from the fixed point 11_{B-1} to the fixed point 11_{B-2} in the image 12.

A synthesized image shown in FIG. 5 is obtained by synthesizing the three images shown in FIG. 3 by the image synthesizing unit 4 in the vehicle driving support apparatus according to the present modified example. In the synthesized image shown in FIG. 5, the three images shown in FIG. 3 are synthesized so that a feeling of distance from the viewing point of the first image capturing unit does not vary in both long distance and short distance in visual lines facing rearward and left/right sides of the vehicle. Therefore, the driver can recognize the synthesized image displayed on the display unit so that a feeling of distance from the viewing point of the first image capturing unit arranged in a rear portion of the vehicle does not vary. Also in the synthesized image shown in FIG. 5, there is no blind area in the rear direction and the left and right directions of the vehicle.

The display unit 5 can display a moving image formed by a series of synthesized images including synthesized images that are continuously synthesized by the image synthesizing unit 4. Thereby, in the moving image displayed on the display unit 5, even while the viewing point of the image capturing unit 1 is moving, the driver can recognize the moving image so that there is no difference between feelings of distance in the rear direction and the left and right directions from the viewing point of the image capturing unit 1 provided in the vehicle 50.

### [Vehicle Driving Support Apparatus According to Second Aspect]

The vehicle driving support apparatus according to the present disclosure is not limited to the vehicle driving support apparatuses according to the aspect (first aspect) described above and the modified example thereof.

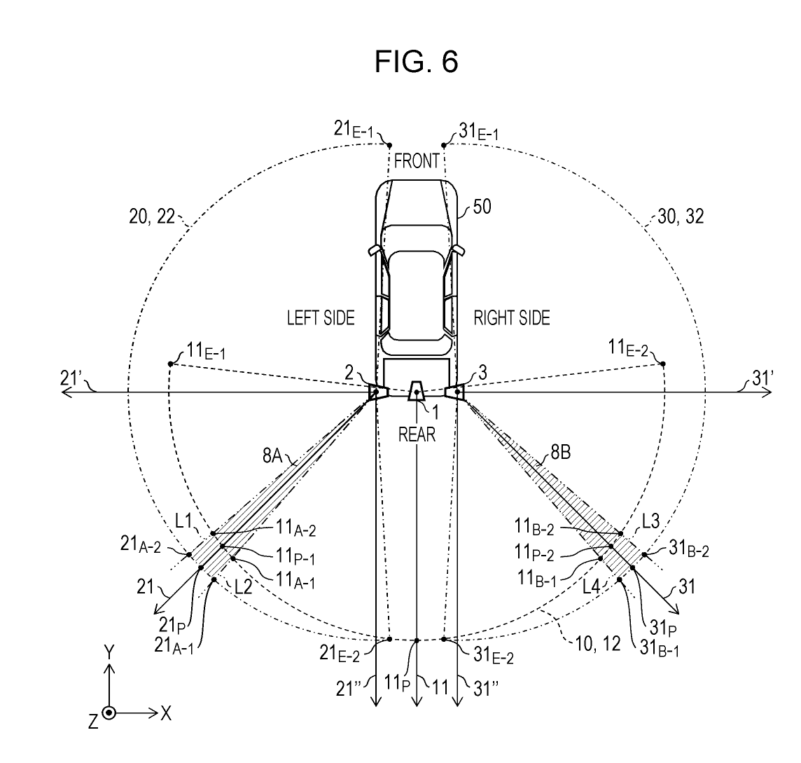

As shown in FIG. 6, in a vehicle driving support apparatus according to an aspect (second aspect), in an overlap area where the imaging area 10 and the imaging area 20 overlap with each other, the image synthesizing unit 4 synthesizes the image 22 and the image 12 so that the size of the scenery shown in the partial area 8A including a fixed point 21_{P} which is shown in the image 22 and through which the visual line 21 passes and the size of the scenery shown in the partial area 8A including a fixed point 11_{P-1} which is shown in the image 12 and through which the visual line 21 passes are matched with each other. Similarly, in an overlap area where the imaging area 10 and the imaging area 30 overlap with each other, the image synthesizing unit 4 synthesizes the image 32 and the image 12 so that the size of the scenery shown in the partial area 8B including a fixed point 31_{P} which is shown in the image 32 and through which the visual line 31 passes and the size of the scenery shown in the partial area 8B including a fixed point 11_{P-2} which is shown in the image 12 and through which the visual line 31 passes are matched with each other.

The visual line 21 of the image capturing unit 2 shown in FIG. 6 can have an arbitrary angle between a visual line 21′ and a visual line 21″. The visual line 31 of the image capturing unit 3 can have an arbitrary angle between a visual line 31′ and a visual line 31″. Here, the visual line 21′ and the visual line 31′ are parallel to the X direction, and the visual line 21″ and the visual line 31″ are perpendicular to the X direction. In other words, the visual line 21 of the image capturing unit 2 starts from the viewing point of the image capturing unit 2 and can face any direction in a range of 90° from the rear direction of the vehicle 50 to the left direction of the vehicle 50. Similarly, the visual line 31 of the image capturing unit 3 starts from the viewing point of the image capturing unit 3 and can face any direction in a range of 90° from the rear direction of the vehicle 50 to the right direction of the vehicle 50. Therefore, also in the vehicle driving support apparatus according to the present aspect, it is possible to synthesize images so that a feeling of distance does not vary in the visual line 11 facing rearward of the vehicle 50, the visual line 21 between the rear direction and the left direction in the rear of the vehicle 50, and the visual line 31 between the rear direction and the right direction in the rear of the vehicle 50.

Positions of fixed points shown in the image 12, positions of fixed points shown in the image 22, and positions of fixed points shown in the image 32 may be calculated in advance from the arrangements and the viewing angles of the image capturing units.

### [Vehicle Driving Support Apparatus According to Third Aspect]

The vehicle driving support apparatus according to the present disclosure is not limited to the vehicle driving support apparatuses according to the aspects (the first aspect and the second aspect) described above and the modified example thereof.

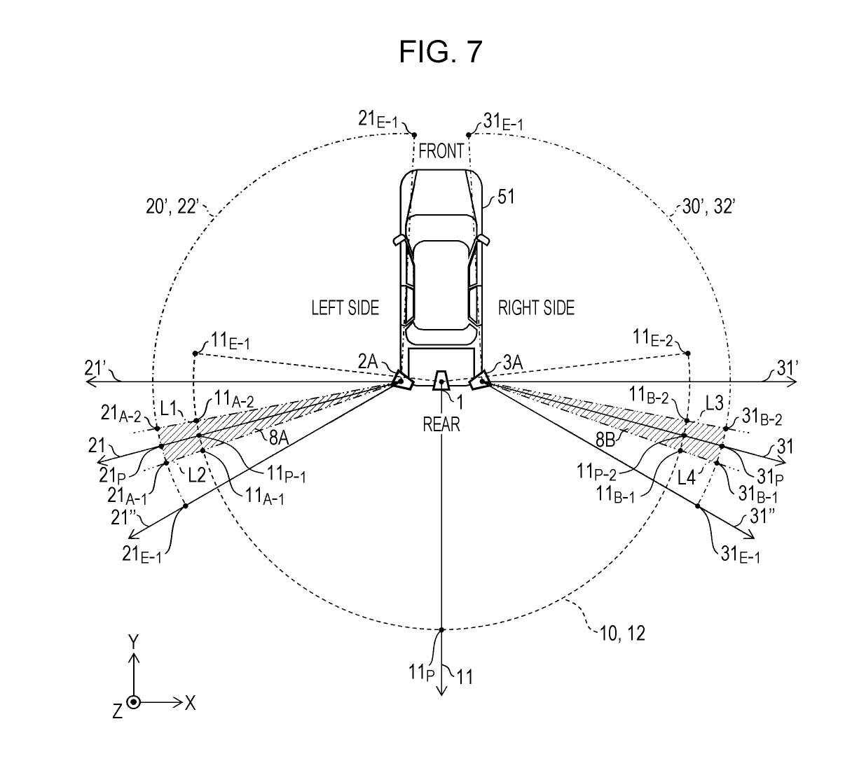

As shown in FIG. 7, in a vehicle driving support apparatus according to an aspect (third aspect), regarding the image synthesizing unit 4, the viewing angles of the imaging area 20′ and the imaging area 30′ are smaller than the viewing angle of the imaging area 10 of the image capturing unit 1. Here, the viewing angle of the imaging area 10 is desirable to be 180° or more and is 190° in the present aspect. The viewing angles of the imaging area 20′ and the imaging area 30′ are 120°.

In the present aspect, the image capturing unit 1, an image capturing unit 2A, and an image capturing unit 3A are arranged so that the viewing points thereof are arranged in a row along a direction (X direction) perpendicular to a traveling direction of a vehicle 51 and are arranged so that the viewing point of the image capturing unit 1 is located between the viewing point of the image capturing unit 2A and the viewing point of the image capturing unit 3A.

When the image capturing unit 2A can capture an image on the left side of the vehicle 51 and has an imaging area that can be overlapped with the imaging area 10, the orientation of the image capturing unit 2A is not limited. Similarly, when the image capturing unit 3A can capture an image on the right side of the vehicle 51 and has an imaging area that can be overlapped with the imaging area 10, the orientation of the image capturing unit 3A is not limited.

The visual line 21 of the image capturing unit 2A shown in FIG. 7 can have an arbitrary angle between a visual line 21′ parallel to the X direction and a visual line 21″ that passes through a fixed point 21_{E-1} that defines the viewing angle of the imaging area 20′. Similarly, the visual line 31 of the image capturing unit 3A can have an arbitrary angle between a visual line 31′ parallel to the X direction and a visual line 31″ that passes through a fixed point 31_{E-1} that defines the viewing angle of the imaging area 30′.

In an overlap area where the imaging area 10 and the imaging area 20′ overlap with each other, the image 22′ and the image 12 are synthesized so that the size of the scenery shown in the partial area 8A including a fixed point 21_{P} which is shown in the image 22′ and through which the visual line 21 passes and the size of the scenery shown in the partial area 8A including a fixed point 11_{P-1} which is shown in the image 12 and through which the visual line 21 passes are matched with each other. Similarly, in an overlap area where the imaging area 10 and the imaging area 30′ overlap with each other, the image 32′ and the image 12 are synthesized so that the size of the scenery shown in the partial area 8B including a fixed point 31_{P} which is shown in the image 32′ and through which the visual line 31 passes and the size of the scenery shown in the partial area 8B including a fixed point 11_{P-2} which is shown in the image 12 and through which the visual line 31 passes are matched with each other. Thereby, also in the vehicle driving support apparatus according to the present aspect, it is possible to synthesize images so that a feeling of distance does not vary in the visual line 11, the visual line 21, and the visual line 31.

### [Vehicle Driving Support Apparatus According to Another Aspect]

The vehicle driving support apparatus according to the present disclosure is not limited to the vehicle driving support apparatuses according to the aspects (the first aspect, the second aspect, and the third aspect) described above. In the vehicle driving support apparatus, the second image capturing unit is an image capturing unit that captures images on the left side of the vehicle (left side of the front passenger seat). Here, the second image capturing unit is arranged in the rear left corner of the vehicle. Although not limited in the present aspect, the first image capturing unit is arranged in the rear right corner of the vehicle and captures a first captured image in a rearward direction of the vehicle. The first and the second image capturing units are arranged so that the viewing points of the first image capturing unit and the second image capturing unit are arranged at corner portions of the vehicle in a row along a direction perpendicular to a traveling direction.

Also in the present aspect, in at least a partial area of an overlapped area where the imaging area of the first image capturing unit and the imaging area of the second image capturing unit are overlapped, the visual line of the image capturing unit 1 and the visual line of the second image capturing unit are arranged so as to be overlapped. In the present aspect, the horizontal viewing angles of the first and the second image capturing units are desirable to be 180° or more and is 190° in the present aspect.

Also by the configuration described above, it is possible to successfully synthesize images so that a feeling of distance does not vary in a direction where the visual line of the image capturing unit 1 and the visual line of the second image capturing unit are overlapped. Further, it is possible to synthesize images so that there is no blind area around the corner between the rear of the vehicle and the left side of the front passenger seat. Therefore, the driver can check areas around the corner between the rear of the vehicle and the left side of the front passenger seat without blind areas by the synthesized image displayed on the display unit.

### [Example Realized by Software]

A control block (in particular, the image synthesizing unit 4, the main control unit 6, and the memory unit 7) of the vehicle driving support apparatus included in the vehicle 50 may be realized by a logic circuit (hardware) formed on an integrated circuit (IC chip) or may be realized by software.

In the latter case, the vehicle driving support apparatus included in the vehicle 50 includes a computer that executes commands of a program which is software that realizes functions. The computer includes, for example, at least one processor (control apparatus) and at least one computer-readable recording medium that stores the program. In the computer, the processor reads the program from the recording medium and executes the program, so that an object of the present disclosure is achieved. As the processor, for example, a CPU (Central Processing Unit) can be used. As the recording medium, a “non-temporary tangible medium”, for example, a ROM (Read Only Memory), a tape, a disk, a card, a semiconductor memory, a programable logic circuit, or the like can be used. A RAM (Random Access Memory) where the program is arranged may be further included. The program may be supplied to the computer through any transmission medium (communication network, broadcast wave, or the like) which can transmit the program. An aspect of the present disclosure can be realized in a form of data signal embedded in a carrier wave, where the program is embodied by electronic transmission.

### [Summary]

A vehicle driving support apparatus according to an aspect 1 of the present disclosure includes the first image capturing unit (the image capturing unit 1) that captures images behind the vehicle 50, the second image capturing unit that captures images on one side of the vehicle 50, the image synthesizing unit 4 that synthesizes images that are respectively captured by the first and the second image capturing units, and the display unit 5 that displays a synthesized image that is synthesized by the image synthesizing unit 4. The second image capturing unit (the image capturing unit 2) is the image capturing unit 2 that captures images on the left side of the front passenger seat of the vehicle 50, or the image capturing unit 2 that captures images on the left side of the front passenger seat and the image capturing unit 3 that captures images on the right side of the driver's seat. The first image capturing unit (the image capturing unit 1) and the second image capturing unit (the image capturing unit 2) are arranged so that the visual line of the first image capturing unit (the image capturing unit 1) and the visual line 21 of the second image capturing unit (the image capturing unit 2) are overlapped in at least a partial area (the partial area 8A) of an overlapped area where the imaging area 10 of the first image capturing unit (the image capturing unit 1) and the imaging area 20 of the second image capturing unit (the image capturing unit 2) are overlapped. When the second image capturing unit is the image capturing unit 2 that captures images on the left side of the front passenger seat and the image capturing unit 3 that captures images on the right side of the driver's seat, the first image capturing unit (the image capturing unit 1) and the second image capturing unit (the image capturing unit 3) are arranged so that the visual line of the first image capturing unit (the image capturing unit 1) and the visual line of the second image capturing unit (the image capturing unit 3) are overlapped in at least a partial area (the partial area 8B) of an overlapped area where the imaging area 10 of the first image capturing unit (the image capturing unit 1) and the imaging area 30 of the second image capturing unit (the image capturing unit 3) are overlapped in the same manner as in the partial area (the partial area 8A).

According to the configuration described above, it is possible to synthesize the first captured image (image 12) and the second captured image (image 22) so that there is no difference between feelings of distance to an object shown in a direction where the visual line of the first image capturing unit (the image capturing unit 1) and the visual line 21 of the second image capturing unit (the image capturing unit 2 and the image capturing unit 3) are overlapped. Further, it is possible to synthesize the first captured image (image 12), the second captured image (image 22), and the second captured image (image 32) so that there is no difference between feelings of distance to an object.

In an vehicle driving support apparatus according to an aspect 2 of the present disclosure, in the aspect 1 described above, the image synthesizing unit 4 matches the size of the object on the first captured image (image 12) captured by the first image capturing unit (the image capturing unit 1) and the size of the object on the second captured image (image 22) captured by the second image capturing unit (the image capturing unit 2) with each other in at least a partial area (the partial area 8A) of the overlapped area, and then synthesizes the first and the second captured images (images 12 and 22). The image synthesizing unit 4 matches the size of the object on the first captured image (image 12) captured by the first image capturing unit (the image capturing unit 1) and the size of the object on the second captured image (image 32) captured by the second image capturing unit (the image capturing unit 3) with each other in a partial area (the partial area 8B), and then synthesizes the first and the second captured images (images 12 and 32).

According to the configuration described above, it is possible to synthesize the first captured image (image 12) and the second captured image (image 22) so that there is no blind area that may occur at a boundary between the first captured image (image 12) and the second captured image (image 22) and it is possible to synthesize the first captured image (image 12) and the second captured image (image 32) so that there is no blind area that may occur at a boundary between the first captured image (image 12) and the second captured image (image 32).

In an vehicle driving support apparatus according to an aspect 3 of the present disclosure, in the aspects 1 or 2, the viewing angles of the image capturing units (the image capturing units 2A and 3A) that captures images on the sides may be smaller than the viewing angle of the first image capturing unit (the image capturing unit 1).

Also in the configuration described above, it is possible to synthesize the first captured image (image 12) and the second captured image (image 22′) so that there is no difference between feelings of distance to an object shown in a direction where the visual line of the first image capturing unit (the image capturing unit 1) and the visual line of the second image capturing unit (the image capturing unit 2A) are overlapped, and it is possible to synthesize the first captured image (image 12) and the second captured image (image 22′) so that there is no blind area that may occur at a boundary between the first captured image (image 12) and the second captured image (image 22′). Similarly, it is possible to synthesize the first captured image (image 12) and the second captured image (image 32′) so that there is no difference between feelings of distance to an object shown in a direction where the visual line of the first image capturing unit (the image capturing unit 1) and the visual line of the second image capturing unit (the image capturing unit 3) are overlapped, and it is possible to synthesize the first captured image (image 12) and the second captured image (image 32′) so that there is no blind area that may occur at a boundary between the first captured image (image 12) and the second captured image (image 32′).

A vehicle driving support apparatus according to an aspect 4 of the present disclosure includes the first image capturing unit (the image capturing unit 1) that captures images behind the vehicle 51, the second image capturing unit that captures images on one side of the vehicle 51, the image synthesizing unit 4 that synthesizes images that are respectively captured by the first image capturing unit (the image capturing unit 1) and the second image capturing unit, and the display unit 5 that displays a synthesized image that is synthesized by the image synthesizing unit 4. The second image capturing unit is the image capturing unit 2 that captures images on the left side of the front passenger seat of the vehicle 51, or the image capturing unit 2 that captures images on the left side of the front passenger seat and the image capturing unit 3 that captures images on the right side of the driver's seat. The first image capturing unit (the image capturing unit 1) and the second image capturing unit (the image capturing unit 2) are arranged so that the imaging area 10 of the first image capturing unit (the image capturing unit 1) and the imaging area 20 of the second image capturing unit (the image capturing unit 2) are overlapped. In at least a partial area (the partial area 8A) of an overlapped area where the imaging area 10 of the first image capturing unit and the imaging area 20 of the second image capturing unit (the image capturing unit 2) are overlapped, the image synthesizing unit 4 matches the size of the object on the first captured image (image 12) captured by the first image capturing unit (the image capturing unit 1) and the size of the object on the second captured image (image 22) captured by the second image capturing unit (the image capturing unit 2) with each other, and then synthesizes the first captured image (image 12) and the second captured image (image 22). In a partial area (the partial area 8B), the image synthesizing unit 4 matches the size of the object on the first captured image (image 12) captured by the first image capturing unit (the image capturing unit 1) and the size of the object on the second captured image (image 32) captured by the second image capturing unit (the image capturing unit 3) with each other, and then synthesizes the first and the second captured images (images 12 and 32).

According to the configuration described above, it is possible to synthesize the first captured image (image 12) and the second captured image (image 22) so that there is no difference between feelings of distance in a direction in which a visual line that passes through at least a partial area (the partial area 8A) of the overlapped area, and it is possible to synthesize the first captured image (image 12) and the second captured image (image 22) so that there is no blind area that may occur at a boundary between the first captured image (image 12) and the second captured image (image 22). Further, it is possible to synthesize the first captured image (image 12) and the second captured image (image 32) so that there is no difference between feelings of distance in a direction in which a visual line that passes through a partial area (the partial area 8B), and it is possible to synthesize the first captured image (image 12) and the second captured image (image 32) so that there is no blind area that may occur at a boundary between the first captured image (image 12) and the second captured image (image 32).

A vehicle driving support program according to an aspect 5 of the present disclosure is a vehicle driving support program for functioning a computer as a vehicle driving support apparatus and causes the computer to function as the image synthesizing unit 4 in the aspect 2 or 4 described above.

According to the configuration described above, it is possible to obtain the same effect as that of the vehicle driving support apparatus in the aspect 2 or 4 described above.

The present disclosure is not limited to the aspects described above, but can be variously modified within the scope of the claims. An aspect obtained by appropriately combining technical units described in different aspects is also included in the technical scope of the present disclosure. Further, it is possible to form novel technical features by combining the technical units disclosed respectively in the aspects.

The present disclosure contains subject matter related to that disclosed in Japanese Priority Patent Application JP 2017-207311 filed in the Japan Patent Office on Oct. 26, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A vehicle driving support apparatus comprising:
a first image capturing unit that captures images behind a vehicle;
a second image capturing unit that captures images on one side of the vehicle;
an image synthesizing unit that synthesizes images that are respectively captured by the first image capturing unit and the second image capturing unit; and
a display unit that displays a synthesized image that is synthesized by the image synthesizing unit,
wherein the second image capturing unit is an image capturing unit that captures images on a side of a front passenger seat of the vehicle, or an image capturing unit that captures images on the side of the front passenger seat and an image capturing unit that captures images on a side of a driver's seat, and
the first and the second image capturing units are arranged so that a visual line of the first image capturing unit and a visual line of the second image capturing unit are overlapped in at least a partial area of an overlapped area where an imaging area of the first image capturing unit and an imaging area of the second image capturing unit are overlapped.

2. The vehicle driving support apparatus according to claim 1, wherein the image synthesizing unit matches a size of an object on a first captured image captured by the first image capturing unit and a size of an object on a second captured image captured by the second image capturing unit with each other in at least a partial area of the overlapped area, and thereafter synthesizes the first captured image and the second captured image.

3. The vehicle driving support apparatus according to claim 1, wherein a viewing angle of the image capturing unit that captures images on a side is smaller than a viewing angle of the first image capturing unit.

4. A vehicle driving support apparatus comprising:
a first image capturing unit that captures images behind a vehicle;
a second image capturing unit that captures images on one side of the vehicle;
an image synthesizing unit that synthesizes images that are respectively captured by the first image capturing unit and the second image capturing unit; and
a display unit that displays a synthesized image that is synthesized by the image synthesizing unit,
wherein the second image capturing unit is an image capturing unit that captures images on a side of a front passenger seat of the vehicle, or an image capturing unit that captures images on the side of the front passenger seat and an image capturing unit that captures images on a side of a driver's seat,
the first image capturing unit and the second image capturing unit are arranged so that an imaging area of the first image capturing unit and an imaging area of the second image capturing unit are overlapped, and
the image synthesizing unit matches a size of an object on a first captured image captured by the first image capturing unit and a size of an object on a second captured image captured by the second image capturing unit with each other in at least a partial area of an overlapped area where the imaging area of the first image capturing unit and the imaging area of the second image capturing unit are overlapped, and thereafter synthesizes the first captured image and the second captured image.

5. A vehicle driving support program for causing a computer to function as the vehicle driving support apparatus according to claim 2, wherein
the vehicle driving support program causes a computer to function as the image synthesizing unit.

6. A vehicle driving support program for causing a computer to function as the vehicle driving support apparatus according to claim 4, wherein
the vehicle driving support program causes a computer to function as the image synthesizing unit.

7. The vehicle driving support apparatus according to claim 2, wherein a viewing angle of the image capturing unit that captures images on a side is smaller than a viewing angle of the first image capturing unit.
